(19) United States
(12) Patent Application Publication
(10) Pub. No.: US 2002/0017362 A1
(43) Pub. Date: Feb. 14, 2002

(54) System for applying A thermoplastic to serge a fabric edge

(76) Inventors: Charles Pearson Covert, Baltimore, MD (US); John A. Neu, Baltimore, MD (US)

Correspondence Address: MCDERMOTT WILL & EMERY, 600 13TH STREET, N.W., WASHINGTON, DC, 20005-3096, US

(21) Appl. No.: 09/878,330

(22) Filed: Jun. 12, 2001

Related U.S. Application Data
(60) Provisional application No. 60/224,001, filed on Aug. 9, 2000.

(51) Int. Cl. B32B 31/00

(52) U.S. Cl. 156/290

(57) ABSTRACT

A system for applying a thin film of molten thermoplastic to the edge of a cut fabric includes a feeder for providing a source of fabric or textile; a slitter for cutting the supplied fabric or textile; and at least one thermoplastic applicator having an applicator tip for applying a molten thermoplastic to the cut fabric. The system provides for cutting fabric and maintaining the integrity of the edge thereof by the application of the molten thermoplastic.

### RELATED APPLICATION

This application claims priority from U.S. Provisional Patent Application Ser. No. 60/224,001, filed Aug. 9, 2000 entitled “AUTOMATIC SYSTEM TO APPLY THERMOPLASTIC SERGE EDGE TO MATTRESS COVERS AND BORDERS” the entire disclosure of which is incorporated herein by reference.

### FIELD OF THE INVENTION

This invention relates to a method and apparatus for manipulating a flexible fabric and, more particularly, to an apparatus that manipulates a panel of fabric for a mattress cover so that all edges thereof can be automatically treated with a thermoplastic film to maintain the integrity of the edges.

### BACKGROUND ART

The demand for consumer fabric products has provided the impetus for developing more efficient, high throughput processes for their production. Consumer goods such as mattresses, quilts, side parts of motor vehicles, room decorations, garments, mattress cover pads, diamond-quilted covering featherbeds, side and rear parts of easychairs, couches, couch seat covers, profiled backs of upholstered furniture, to mention a few, require varying amounts of manual labor that increase the costs of producing such goods. Many of the consumer goods are multilayered products containing a layer of fabric on one or more foamed plastic materials, such as polyurethane foams, which are of great importance as a filler for cushions, pads, linings of motor vehicle bodies, airplane cabins etc.

Modem mattresses, for example, generally include an inner construction and an outer mattress cover that consists of one or more layers of fabric sewn to one or more layers of foam. The fabric material of the mattress cover can be of many types, such as flat or quilted, and generally includes identical top and bottom panels and a side panel (otherwise known as the border or border panel), joining the top and bottom panels. “Sizing” is a term known in the art and is used to refer to the uniformity of a mattress's stitching and dimensions, and more generally to its appearance.

Conventionally, the panels are prepared from a large roll of material that is cut to the proper dimensions to form top, bottom and side panels (or border) and then the edges thereof are sewn to prevent fraying. Thereafter, the top and bottom panel are joined directly to the side panel, by a separate sewing process, to form the mattress cover or sack. For example, in U.S. Pat. No. 5,529,004 Porter et al. disclose a method and apparatus for sewing panels together to produce a mattress sack. Their solution for producing the mattress sack includes a modified conventional sewing machine to better manipulate the panels being sewn together. However, sewing cut fabric and attaching the panels by means of sewing the pieces together is time consuming and requires special equipment.

Methods and specialty apparatus have also been developed to produce hems on cloth articles. For example, U.S. Pat. No. 3,856,599 to Bylund discloses a sealed edge cutting method for forming such items such as diapers and handkerchiefs. The method includes sealing a thermoplastic film onto a roll of fabric and then cutting the fabric in the middle of the film to form a product with two sealed edges. U.S. Pat. No. 3,905,860 to Emus, discloses an apparatus for depositing an adhesive in the fold of a hem then folding the fabric to secure the hem without stitching. U.S. Pat. No. 4,096,016 to Pohl teaches a process for making a seam weld by the use of discreet resin particles together with a high frequency electric field. The art, however, requires the additional manipulation of fabric or special apparatus for their operation and have not been applied to the mattress industry.

Accordingly, a continuing need exists for an apparatus that manipulates flexible fabric in a time and cost efficient manner. Additionally, a need exists for processing fabric so that cut edges thereof defy unraveling and endure being incorporated in to manufactured articles during high-volume, product-assembly processes, such as in the fabrication of mattress sacks.

### DISCLOSURE OF THE INVENTION

An advantage of the present invention is an apparatus and method of cutting a fabric and maintaining the integrity of the cut edge without the need for additional sewing, stitching, folding, etc.

Additional advantages and other features of the invention will be set forth in the description which follows and in part will be apparent to those having ordinary skill in the art upon examination of the following or may be learned from the practice of the present invention. Advantages of the present invention may be realized and particularly pointed out in the appended claims.

According to the present invention, the foregoing and other advantages are achieved in part by a method of manipulating a fabric, particularly a flexible supported fabric, e.g. a fabric having bond thereto one or more layers of foam, such as a mattress cover or border. The method comprises applying a thin film of a molten thermoplastic to a cut edge of the fabric.

In practicing the present invention, one or more layers of a molten thermoplastic, as in a hot-melt adhesive, is applied to the edge of a cut material, e.g. a supported fabric, to advantageously reduce or eliminate fraying at the material's edges thereby providing a more durable edge.

Embodiments of the present invention include cutting a fabric having one or more layers of foam attached thereto to a width of about 4 inches to about 24 inches; continuously supplying a source of the fabric having the foam; continuously cutting the fabric and foam; continuously applying a molten film of thermoplastic, e.g. ethylene vinyl acetate copolymers, to the edge of the cut material; and compressing the edge of the cut material having the applied thermoplastic.

Another aspect of the present invention is an apparatus comprising a feeder for providing a source of fabric; a cutter or slitter for cutting the supplied fabric; and at least one thermoplastic applicator having an applicator tip for applying molten thermoplastic to the edge of the cut fabric.

Embodiments of the present invention include a mounting beam for supporting the at least one thermoplastic applicator; a thermoplastic supply unit in fluid communication with the at least one thermoplastic applicator for supplying a molten thermoplastic thereto; at least one heated delivery tube connecting the supply unit to the applicator; a controller connected to either the thermoplastic supply unit or applicator or both for regulating the temperature and pressure of the thermoplastic supplied to the thermoplastic applicator; and a pair of opposing rolling pins for compressing the fabric following application of the thermoplastic.

A further aspect of the present invention includes an article of manufacture comprising a supported fabric having width of about 4 inches to about 24 inches and having opposing edges composed of fibers. The supported fabric can be a non-woven fabric having one or more layers of foam attached along the entire width of the fabric, as in a border panel. A thin film, e.g. about 1 to about 5 mils thick, of thermoplastic material is on the edge of the supported fabric and can be from about 1/16th to about 1 inch wide.

Additional advantages and other features of the present invention will become readily apparent to those skilled in this art from the following detailed description, wherein only the preferred embodiment of the present invention is shown and described, simply by way of illustration of the best mode contemplated for carrying out the present invention. As will be realized, the present invention is capable of other and different embodiments, and its several details are capable of modifications in various obvious respects, all without departing from the present invention. Accordingly, the drawings and description should be regarded as illustrative in nature, not as restrictive.

### BRIEF DESCRIPTION OF DRAWINGS

The various features and advantages of the present invention will become more apparent and facilitated by reference to the accompanying drawings, submitted for purposes of illustration and not to limit the scope of the invention, where the same numerals represent like structure and wherein:

FIG. 1 schematically illustrates a plan view of an embodiment of an apparatus in accordance with the present invention.

FIG. 2 schematically illustrates a plan view of an embodiment the present invention.

### DESCRIPTION OF THE INVENTION

The present invention addresses and solves the problem of fraying or the otherwise unraveling of the edge of a cut fabric (also known in the art as a textile), particularly the border of a mattress cover. As used herein “border” refers to the side panel of a mattress. The inventive system is simple in use and assembly and includes the application of a molten or flowable thermoplastic on the edge of a fabric, e.g. a supported fabric as in a non-woven fabric supported on a layer of foamed plastic.

The present invention does not require specialty apparatus or methods that include an electric field, as in high frequency seam welding, or the complexities of folding the fabric at its edge. The present invention substantially reduces, if not completely eliminates, the fraying of the edge of a supported fabric, e.g. a border, thereby avoiding the need to sew or stitch a processed supported fabric prior to assembly, as in the joining of the top and bottom panel to a border in the fabrication of a mattress cover or sack.

The thermoplastic used in the present invention can be formulated as an adhesive or hot-melt composition and applied to the top, bottom, or side edge of the fabric so that it flows through or around the threads or fibers making up the fabric to substantially maintain the integrity of the cut edge thereby reducing or eliminating the deleterious effects of cutting the fabric. The present invention is amenable to the textile and garment industries where high-volume, continuous manufacture of articles are desirable.

In practicing the present invention, a fabric is supplied or fed from a source, such as a wound roll, as is known in the art or any equivalents thereof, through a cutter or slitter to provide a fabric or textile having a cut edge and a desired size. The present invention contemplates an apparatus for applying a thermoplastic layer on to the surface, e.g. the top surface, of the cut edge of the fabric.

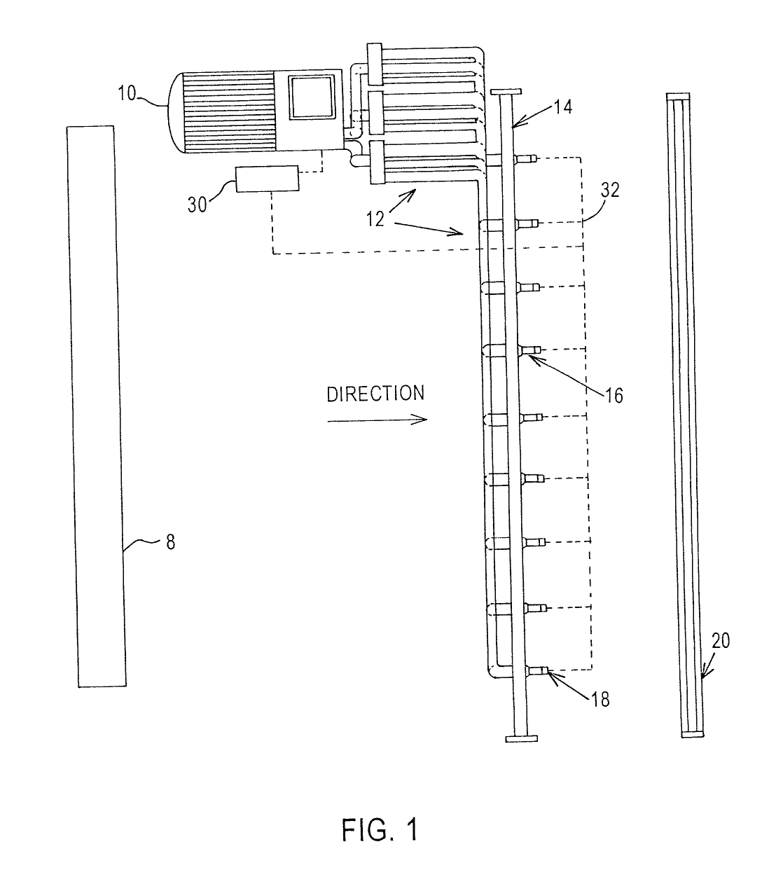

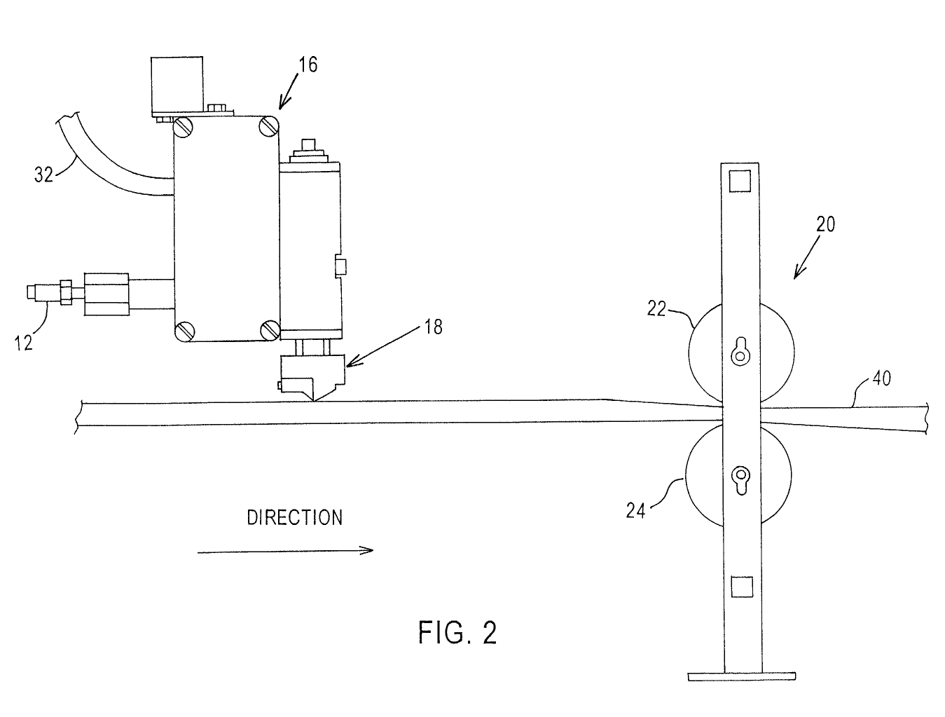

In high-volume production, the inventive apparatus can include several thermoplastic applicators. In an embodiment of the present invention, FIGS. 1-2 illustrate an apparatus for applying a thermoplastic to serge a fabric edge. As shown, fed dolly 8 supplies fabric in the direction shown, e.g. toward a thermoplastic applicator. Thermoplastic supply unit 10 is used to house the thermoplastic and is in fluid communication with a plurality of thermoplastic applicators 16 by a series of hoses or pipes 12. In one aspect of the present invention, the thermoplastic supply unit is connected to the applicators by a series of heated delivery tubes. Such tubes or pipes can have a Teflon coated interior and can be wrapped with heating tape and insulation to facilitate transport of the thermoplastic and maintain a desired temperature.

The applicators can be supported by mounting beam 14. The mounting beam can further support and supply compressed gases, e.g. air, to the applicators and can support electrical power, signal cables or wires, or anything that is desirable for communicating with or controlling the applicators.

Applicator 16 of the present invention comprise applicator tip 18 for directing the molten thermoplastic onto the fabric edge. The applicator of the present invention contains a heater and a pneumatic valving mechanism (not shown for illustrative convenience) that heats, traps and pressurizes the delivered thermoplastic and forces molten thermoplastic through a slit, slot dye, or small orifice through the tip or nozzle of the applicator. Applicators useful in the present invention can pressurize the thermoplastic up to about 900 psi and maintain a temperature of about 100-450° F. Such thermoplastic applicators are commercially available, as from the Covert Company, Inc. of Maryland.

In one aspect of the present invention, the apparatus comprises controller 30 in electrical connection 32 with applicators 16 and supply unit 10. The controller can be used to sense and regulate the temperature and pressure of the thermoplastic housed in supply unit 10 and applicator 16 prior to being applied to the edge of the cut materials. Although not illustrated, the controller is also useful for sensing and regulating the temperature of heated delivery tubes connecting supply unit 10 and applicator 16. The apparatus can further have a mechanism (electrical or mechanical) to sound an alarm when any variable falls below an undesirable limit.

The inventive apparatus advantageously applies a temperature-controlled amount of a thermoplastic onto the edge of a fabric, e.g. a supported fabric. As shown in FIG. 2, supported fabric 40 moves through a stationary apparatus. The inventive apparatus is not limited, however, to being stationary and variations of movement of the apparatus relative to the supported fabric are contemplated by the present invention as, for example, a stationary fabric and moving apparatus.

In another aspect of the inventive apparatus, a pair of supported opposing rollers 22 and 24 compress and/or drive the supported fabric through the apparatus. The top view of the opposing rollers is shown in FIG. 1 as numeral 20. The opposing rollers can be made of metal or ceramic and coated with a non-stick coating, such as Teflon, and can aid in the application of the thermoplastic to or through the fabric, if desired.

The various features and advantages of the present invention will become more apparent and facilitated by a description of its operation. As described above, the present inventive apparatus comprises an applicator for applying a molten thermoplastic to the cut edge of a fabric.

In practicing the invention, a supply of cut fabric, e.g. a supply of cut supported fabric, is provided. The fabric can be any of those used in the textile or fabric industries or any equivalence thereof. The fabric and textiles that can benefit from the present invention includes a wide range of materials, such as woven fabrics, bobinets, knitted fabrics, stitchable knitted fabrics, needle-punched pile fabrics, textile fabrics having adhered tufts, foam-bonded textile fabrics, cellulose, wadding and felt. Reference should also be made in this connection to reinforced fabrics, which may be reinforced by arrays of filaments or threads, woven fabrics, knitted fabrics, nettings and plastics material sheeting. The materials can be a multilayered structure such as a fabric sewn to a foam layer and a non-woven fabric.

In an embodiment of the present invention, the fabric is a supported fabric comprising a woven fabric containing natural or synthetic fibers or blends thereof attached to a support. The support can be selected from a wide range of materials including one or more flexible layers of foam, such as polyurethane, polyester, cellulose foams, etc., as used in the garment and mattress industries. The support can further comprise one or more flexible layers of a non-woven or woven materials. The support can be attached to the fabric mechanically, as by stitching or adhesively, as by gluing. The fabric and support are generally of the same length and width dimensions although the support is generally thicker than the fabric. The support is fastened to the fabric so that the entire fabric is supported. In one aspect of the present invention, the supported fabric comprises a woven fabric sewn to a layer of flexible foam with an optional layer of non-woven material on the back of the foam, such as a mattress panel.

Supported fabrics, such as mattress panels, can be made by stitching a woven fabric to a foam support with or without a1 layer of non-woven backing material (on the backside of the foam). Fabrics and foams can be obtained from commercial sources, such as the Burlington House of North Carolina or from Leggett & Platt of Missouri. Conventional textile machines can be used to attach the fabric to the foam and to cut the supported fabric to a desired size, as known in the garment and textile industries. Useful textile machines include, for example, an Emco quilter and additional textile quilters can be commercially obtained from Gribetz International of Florida.

Fabrics and foams can be provided in rolls as on a dolly and fed to the quilter/cutter to produce a supported fabric having at least one cut edge. The edges are typically composed of the fibers that make up the fabric and are susceptible to fraying. In an embodiment of the present invention, the supported fabric comprises a non-woven fabric sewn to one or more layers of foam support having a width of about 4 inches to 24 inches and having opposing edges composed of fibers. The present invention is not limited in width dimensions and other widths of the supported fabric are contemplated. In an embodiment of the present invention the supported fabric has a width of about 6, 10, 12, 14, 16, 18 inches or any range therein. Such cut supported fabrics are useful as borders in the manufacture of mattress sacks or covers.

A thermoplastic applicator then applies a film of molten thermoplastic to at least one of the edge, e.g. to the top surface thereof, of the cut fabric thereby forming a more durable edge, that is the edge is serged by the application of the thermoplastic to prevent fraying. In an embodiment of the present invention, molten thermoplastic is applied to both opposing edges.

One or more layers of a molten thermoplastic can be applied to the cut edge of the fabric. Suitable thermoplastics that can be used in the present invention include base polymers such as styrenic block copolymers (SBC), ethylene vinyl acetate copolymers (EVA), low-density polyethylene (LDPE), amorphous polyolefins (APO), amorphous poly-alpha-olefins (APAO), polyvinylacetate (PVA), polyvinylchloride (PVC), polyamides, acrylics, acrylic esters, blends, copolymers thereof, and any equivalents thereof. These thermoplastic materials can be blended with various additives, which may include tackifiers, oils, inorganic fillers, and antioxidants. The present invention also contemplates that the thermoplastic is formulated as a hot-melt adhesive and the hot-melt adhesive applied to the cut edge.

Although the thickness and width of the applied thermoplastic will depend on such factors as the fabric and support materials, the particular thermoplastic, and the intended article of manufacture, generally, a thin film of about 1-5 mils thick and about 1/16 to about 1 inch in width is contemplated.

Only the preferred embodiment of the present invention and but a few examples of its versatility are shown and described in the present disclosure. It is to be understood that the present invention is capable of use in various other combinations and environments and is capable of changes and modifications within the scope of the inventive concept as expressed herein.

What is claimed is:

1. A method of serging a fabric, the method comprises:
applying a thin film of a molten thermoplastic to a cut edge of a supported fabric.

2. The method according to claim 1, comprising cutting the supported fabric wherein the supported fabric comprises fabric attached to one or more layers of foam.

3. The method according to claim 1, comprising applying the molten thermoplastic to a fabric that is initially substantially free of any thermoplastic material at its edge.

4. The method according to claim 1, comprising continuously supplying a source of supported fabric; continuously cutting the source of supported fabric and continuously applying the thin film of molten thermoplastic to the cut edge thereof.

5. The method according to claim 1, comprising applying molten ethylene vinyl acetate copolymer as the molten thermoplastic.

6. The method according to claim 1, comprising applying the molten thermoplastic to the top surface of the cut edge of the supported fabric.

7. The method according to claim 1, comprising cutting the supported fabric wherein the supported fabric comprises a fabric having one or more layers of polyurethane foam attached thereto.

8. The method according to claim 1, comprising compressing the cut edge of the supported fabric having the applied molten thermoplastic thereon.

9. The method according to claim 1, comprising applying the molten thermoplastic at a temperature of about 200° F. to about 400° F.

10. The method according to claim 1, comprising cutting the supported fabric to a width of about 4 inches to about 24 inches.

11. The method according to claim 1, comprising:
continuously supplying a fabric having one or more layers of foam attached thereto as the supported fabric;
continuously cutting the supported fabric to a width of about 4 inches to about 24 inches; and
continuously applying the molten thermoplastic to the cut edge of the supported fabric.

12. An apparatus for cutting fabric and maintaining its integrity comprising:
a feeder for providing a source of fabric;
a cutter or slitter for cutting the supplied fabric; and
at least one thermoplastic applicator having an applicator tip for applying a molten thermoplastic to the cut fabric.

13. The apparatus according to claim 12, comprising a pair of opposing rolling pins for compressing the fabric following the application of the molten thermoplastic.

14. The apparatus according to claim 12, comprising a thermoplastic supply unit in fluid communication with the at least one thermoplastic applicator for supplying molten thermoplastic thereto.

15. The apparatus according to claim 14, comprising at least one heated delivery connection between the thermoplastic supply unit and the at least one thermoplastic applicator.

16. The apparatus according to claim 12, comprising a mounting beam for supporting the at least one thermoplastic applicator.

17. The apparatus according to claim 12, comprising a controller for regulating the temperature and pressure of the thermoplastic applicator.

18. An article of manufacture comprising:
a fabric having a width of about 4 inches to about 24 inches and having opposing edges composed of fibers;
one or more layers of foam attached along the entire width of the fabric; and
a thin film of thermoplastic on and between the fibers on at least one edge of the fabric.

19. The article according to claim 18, wherein the fabric is made of natural or synthetic fibers and the thermoplastic film has a width of about 1/16th of an inch to about 1 inch.

20. The article according to claim 18, wherein the foam is sewn to the fabric.
